(19) United States
(12) Patent Application Publication
(10) Pub. No.: US 2011/0026561 A1
(43) Pub. Date: Feb. 3, 2011

(54) TEMPERATURE INFORMATION OUTPUTTING CIRCUIT AND A SEMICONDUCTOR MEMORY APPARATUS USING THE SAME

(75) Inventor: Mi Hyun HWANG, Gyeonggi-do (KR)

Correspondence Address: LADAS & PARRY LLP, 224 SOUTH MICHIGAN AVENUE, SUITE 1600, CHICAGO, IL, 60604, US

(73) Assignee: HYNIX SEMICONDUCTOR INC., Gyeonggi-do (KR)

(21) Appl. No.: 12/648,505

(22) Filed: Dec. 29, 2009

(30) Foreign Application Priority Data
Jul. 31, 2009 (KR) 10-2009-0070782

(51) Int. Cl. G01K 7/00

(52) U.S. Cl. 374/170; 374/E07.001

(57) ABSTRACT

A temperature information outputting circuit of a semiconductor memory apparatus for accurately performing a temperature measuring test is presented. The temperature information outputting circuit includes first, second and third temperature information outputting units. The first temperature information outputting unit outputs a first temperature information signal to a single temperature information outputting pad when a first test signal is enabled. The second temperature information outputting unit stores a second temperature information signal when the first test signal is enabled and outputs the stored second temperature information signal to the single temperature information outputting pad when a second test signal is enabled. The third temperature information outputting unit stores a third temperature information signal when the first test signal is enabled and outputs the stored third temperature information signal to the single temperature information outputting pad when a third test signal is enabled.

### CROSS-REFERENCES TO RELATED PATENT APPLICATION

The present application claims priority under 35 U.S.C 119(a) to Korean Application No. 10-2009-0070782, filed on Jul. 31, 2009, in the Korean Intellectual Property Office, which is incorporated herein by reference in its entirety as set forth in full.

### BACKGROUND

1. Technical Field

The embodiment described herein relates to a semiconductor memory apparatus and, more particularly, to a temperature information outputting circuit and a semiconductor memory apparatus using the same.

2. Related Art

All internal circuits configuring a semiconductor memory apparatus are formed of transistors.

The semiconductor memory apparatus sensitively responds to temperature due to the characteristics of the transistor of which threshold voltage level varies according to the change in ambient temperature.

A typical semiconductor memory apparatus is configured to store data information in a capacitor and output the stored data information and repeats a refresh operation at each set period so as not to lose the data information stored in a capacitor. The refresh operation is an essential operation to maintain the data stored in the semiconductor memory apparatus.

If the threshold voltage level of the transistor becomes low due to the rise in temperature, a leakage current from the capacitor is increased, such that the period of the refresh operation should also correspondingly be fast, while if the threshold voltage level of the transistor rises due to the fall in temperature, the leakage current from the capacitor is small, such that the period of the refresh operation may correspondingly be slow.

Currently, the tendency of the semiconductor memory apparatus changes the period of the refresh operation according to the change in temperature. Even though the characteristics of the semiconductor apparatus responding to the change in temperature only with regards to the refresh operation were described, the possible use of the change in temperature in the internal circuit of the semiconductor memory apparatus formed of the transistor is infinite.

Therefore, a temperature detecting circuit, which can detect the change in temperature, is designed inside the semiconductor memory apparatus. In order to test whether temperature is accurately detected, a need exists for a circuit that outputs the temperature information detected in the temperature detecting circuit to the outside of the semiconductor memory apparatus when the test is performed.

The related art needs the temperature detecting circuit that can detect only temperature more than or less than a preset temperature. Currently, the temperature detecting circuit, which can detect a plurality of preset temperatures, is needed. Therefore, a need exists for a temperature information outputting circuit that can output a plurality of temperature information signals to the outside of the semiconductor memory apparatus through one pad when the test is performed.

### SUMMARY

A temperature information outputting circuit of a semiconductor memory apparatus capable of outputting a plurality of temperature information signals or information codes to one pad and a semiconductor memory apparatus using the same are disclosed herein.

A temperature information outputting circuit of a semiconductor memory apparatus according to one embodiment of the present invention responds to a test signal that is first enabled among a plurality of test signals to store a plurality of temperature information signals and responds to the plurality of test signals to sequentially output the stored temperature information signals to one temperature information outputting pad.

A temperature information outputting circuit of a semiconductor memory apparatus according to another embodiment of the present invention includes: a first temperature information outputting unit that outputs a first temperature information signal to a temperature information outputting pad when a first test signal is enabled; a second temperature information outputting unit that stores a second temperature information signal when the first test signal is enabled and outputs the stored temperature information signal to the temperature information outputting pad when a second test signal is enabled; and a third temperature information outputting unit that stores a third temperature information signal when the first test signal is enabled and outputs the stored temperature information signal to the temperature information outputting pad when a third test signal is enabled.

A temperature information outputting circuit of the semiconductor memory apparatus according to still another embodiment of the present invention stores the plurality of temperature information signals at a specific timing and sequentially outputs the stored signals to a temperature information outputting pad.

A semiconductor memory apparatus using a temperature information outputting circuit according to one embodiment of the present invention responds to a test signal that is first enabled among a plurality of sequentially enabled test signals to store information codes changed in real time and responds to the plurality of test signals to sequentially output the stored information codes to one pad.

A semiconductor memory apparatus using a temperature information outputting circuit according to another embodiment of the present invention simultaneously stores information codes changed in real time at a timing when a test signal is enabled and sequentially outputs each bit of the stored information code to the outside of the semiconductor memory apparatus through one pad whenever a preset time elapses after the test signals are enabled.

These and other features, aspects, and embodiments are described below in the section “Detailed Description.”

### BRIEF DESCRIPTION OF THE DRAWINGS

Features, aspects, and embodiments are described in conjunction with the attached drawings, in which:

FIG. 1 is a diagram showing a configuration of a temperature information outputting circuit of a semiconductor memory apparatus according to one embodiment;

FIG. 2 is a diagram showing a configuration of a temperature information outputting circuit of a semiconductor memory apparatus according to another embodiment; and

FIG. 3 is a diagram showing a configuration of a temperature information outputting circuit of a semiconductor memory apparatus according to still another embodiment.

### DETAILED DESCRIPTION

Hereinafter, preferred embodiments will be described in more detail with reference to the accompanying drawings.

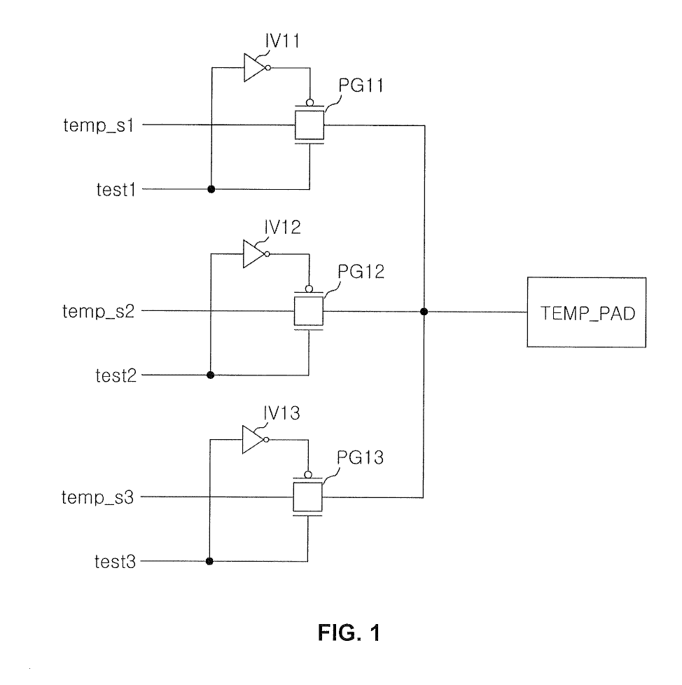

A temperature information outputting circuit of a semiconductor memory apparatus according to one embodiment can sequentially output a plurality of temperature information signals ‘temp_s1’ to ‘temp_s3’ to one pad ‘TEMP_PAD’ by sequentially enabling a plurality of test signals ‘test1’ to ‘test3’ as shown in FIG. 1.

The temperature information outputting circuit of the semiconductor memory apparatus according to the embodiment is configured to include first to third inverters ‘IV11’ to ‘IV13’ and first to third pass gates ‘PG11’ to ‘PG13’. The first inverter ‘IV11’ is configured to receive a first test signal ‘test1’. The first pass gate ‘PG11’ is configured to have a first control end that receives an output signal from the first inverter ‘IV11’; a second control end that receives the first test signal ‘test1’; and an input end that receives a first temperature information signal ‘temp_s1’. The second inverter ‘IV12’ is configured to receive a second test signal ‘test2’. The second pass gate ‘PG12’ is configured to have a first control end that receives an output signal from the second inverter ‘IV12’; a second control end that receives the second test signal ‘test2’; and an input end that receives a second temperature information signal ‘temp_s2’. The third inverter ‘IV13’ is configured to receive a third test signal ‘test3’. The third pass gate ‘PG13’ is configured to have a first control end that receives an output signal from the third inverter ‘IV13’; a second control end that receives the third test signal ‘test3’; and an input end that receives a third temperature information signal ‘temp_s3’. At this time, the temperature information outputting pad ‘TEMP_PAD’ is configured to connected to a node to which each output end of the first to third pass gates ‘PG11 to PG13’ are commonly connected.

The temperature information outputting circuit of the semiconductor memory apparatus according to the embodiment configured as above is operated as follows.

The first to third temperature information signals ‘temp_s1 to temp_s3 ’ are simultaneously output from a temperature detecting circuit (not shown).

First, the first temperature information signal ‘temp_s1’ is output to the temperature information outputting pad ‘TEMP_PAD’ by enabling the first test signal ‘test1’.

Next, the second temperature information signal ‘temp_s2’ is output to the temperature information outputting pad ‘TEMP_PAD’ by enabling the second test signal ‘test2’.

Finally, the third temperature information signal ‘temp_s3’ is output to the temperature information outputting pad ‘TEMP_PAD’ by enabling the test signal ‘test3’.

The operation is performed at the time of the test, making it possible to output the plurality of temperature information signals through one pad. Since temperature changes as a function of real time, then the temperature detecting circuit is configured to be able to output a plurality of temperature information signals as a function of real time.

However, the temperature information outputting circuit of the semiconductor memory apparatus according to the embodiment shown in FIG. 1 sequentially enables the plurality of test signals to sequentially output the plurality of temperature information signals. Therefore, after one test signal is enabled, since the temperature may change before the next test signal is enabled, then the temperature information outputting circuit of the semiconductor memory apparatus, according to the embodiment as shown in FIG. 1, may not necessarily be an accurate reflection of the temperature at a specific time.

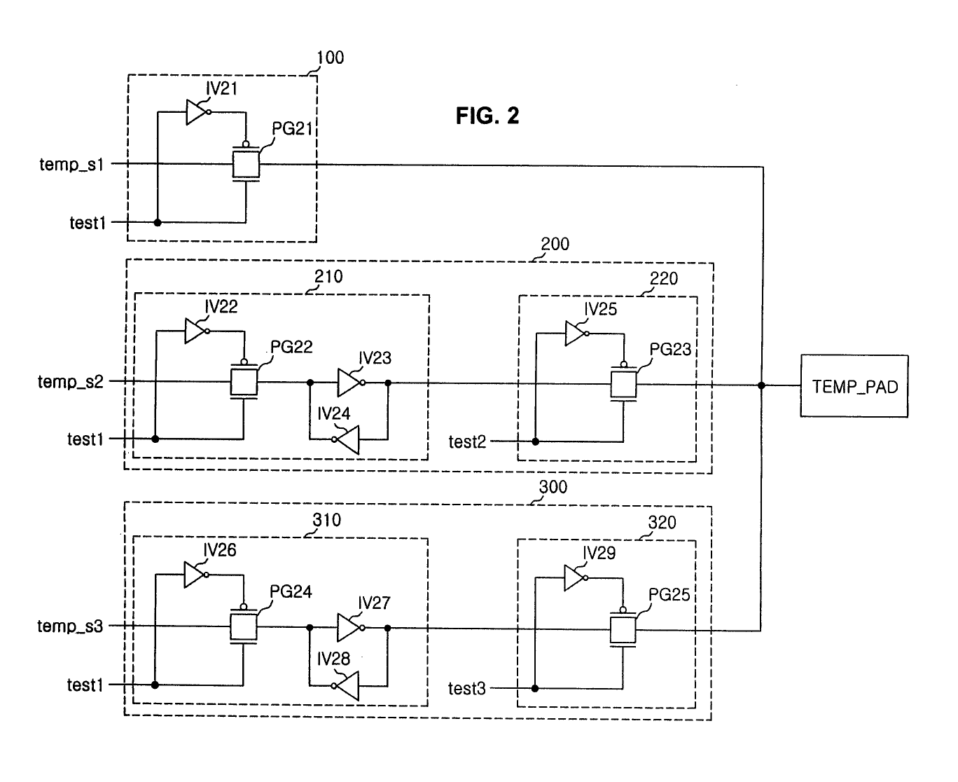

To this end, the temperature information outputting circuit of the semiconductor memory apparatus according to yet another embodiment as shown in FIG. 2.

The temperature information outputting circuit of the semiconductor memory apparatus according to another embodiment shown in FIG. 2 is configured to include a first temperature information outputting unit 100, a second temperature information outputting unit 200, and a third temperature information outputting unit 300.

The first temperature information outputting unit 100 is configured to output the first temperature information signal ‘temp_s1’ to a temperature information outputting pad ‘TEMP_PAD’ when the first test signal ‘test1’ is enabled.

The first temperature information outputting unit 100 is configured to include a first inverter ‘IV21’ and a first pass gate ‘PG21’. The first inverter ‘IV21’ is configured to receive the first test signal ‘test1’. The first pass gate ‘PG21’ is configured to have a first control end that receives an output signal from the first inverter ‘IV21’; a second control end that receives the first test signal ‘test1’; an input end that receives a first temperature information signal ‘temp_s1’; and an output end that is connected to the temperature information outputting pad ‘TEMP_PAD’.

A second temperature information outputting unit 200 is configured to store the second temperature information signal ‘temp_s2’ when the first test signal ‘test1’ is enabled and configured to output the stored second temperature information signal ‘temp_s2’ to the temperature information output pad ‘TEMP_PAD’ when the second test signal ‘test2’ is enabled.

The second temperature information outputting unit 200 is configured to include a first latch unit 210 and a first switching unit 220.

The first latch unit 210 is configured to store the second temperature information signal ‘temp_s2’ when the first test signal ‘test1’ is enabled.

The first latch unit 210 is configured to include second to fourth inverters ‘IV22’, ‘IV23’, and ‘IV24’ and a second pass gate ‘PG22’. The second inverter ‘IV22’ is configured to receive the first test signal ‘test1’. The second pass gate ‘PG22’ is configured to have a first control end that receives an output signal from the second inverter ‘IV22’; a second control end that receives the first test signal ‘test1’; and an input end that receives a second temperature information signal ‘temp_s2’. The third inverter ‘IV23’ is configured to receive an output signal from the second pass gate ‘PG22’. The fourth inverter ‘IV24’ is configured to receive an output signal from the third inverter ‘IV23’ and is configured to output its own output as an input signal from the third inverter ‘IV23’.

The first switching unit 220 is configured to output an output signal from the first latch unit 210 to the temperature information outputting pad ‘TEMP_PAD’ when the second test signal ‘test2’ is enabled.

The first switching unit 220 is configured to include a fifth inverter ‘IV25’ and a third pass gate ‘PG23’. The fifth inverter ‘IV25’ is configured to receive the second test signal ‘test2’. The third pass gate ‘PG23’ is configured to have a first control end that receives an output signal from the fifth inverter ‘IV25’; a second control end that receives the second test signal ‘test2’; an input end that receives an output signal from the first latch unit 210; and an output end that is connected to the temperature information outputting pad ‘TEMP_PAD’.

Third temperature information outputting unit 300 is configured to store the third temperature information signal ‘temp_s3’ when the first test signal ‘test1’ is enabled. Third temperature information outputting unit 300 is also configured to output the stored third temperature information signal ‘temp_s3’ to the temperature information output pad ‘TEMP_PAD’ when the third test signal ‘test3’ is enabled.

The third temperature information outputting unit 300 is configured to include a second latch unit 310 and a second switching unit 320.

The second latch unit 310 is configured to store the third temperature information signal ‘temp_s3’ when the first test signal ‘test1’ is enabled.

The second latch unit 310 is configured to include sixth to eighth inverters ‘IV26’, ‘IV27’, and ‘IV28’ and a fourth pass gate ‘PG24’. The sixth inverter ‘IV26’ is configured to receive the first test signal ‘test1’. The fourth pass gate ‘PG24’ is configured to have a first control end that receives an output signal from the sixth inverter ‘IV26’; a second control end that receives the first test signal ‘test1’; and an input end that receives a third temperature information signal ‘temp_s3’. The seventh inverter ‘IV27’ is configured to receive an output signal from the fourth pass gate ‘PG24’. The eighth inverter ‘IV28’ is configured to receive an output signal from the seventh inverter ‘IV27’ and is configured to output its own output as an input signal from the seventh inverter ‘IV27’.

The second switching unit 320 is configured to output an output signal from the second latch unit 310 to the temperature information outputting pad ‘TEMP_PAD’ when the third test signal ‘test3’ is enabled.

The second switching unit 320 is configured to include a ninth inverter ‘IV29’ and a fifth pass gate ‘PG25’. The ninth inverter ‘IV29’ is configured to receive the third test signal ‘test3’. The fifth pass gate ‘PG25’ is configured to have a first control end that receives an output signal from the ninth inverter ‘IV29’; a second control end that receives the third test signal ‘test3’; an input end that receives an output signal from the second latch unit 310; and an output end that is connected to the temperature information outputting pad ‘TEMP_PAD’.

A temperature information outputting circuit of the semiconductor memory apparatus according to another embodiment configured as above is operated as follows.

The first to third temperature information signals ‘temp_s1 to temp_s3’ are simultaneously output from a temperature detecting circuit (not shown).

The first temperature information signal ‘temp_s1’ is output to the temperature information outputting pad ‘TEMP_PAD’ when the first test signal ‘test1’ is enabled.

When the first test signal ‘test1’ is enabled, the second temperature information signal ‘temp_s2’ is stored and when the second test signal ‘test2’ is enabled, the second temperature information signal ‘temp_s2’ is output to the temperature information output pad ‘TEMP_PAD’.

When the first test signal ‘test1’ is enabled, the third temperature information signal ‘temp_s3’ is stored and when the third test signal ‘test3’ is enabled, the third temperature information signal ‘temp_s3’ is output to the temperature information output pad ‘TEMP_PAD’.

Consequently, a temperature information output circuit of the semiconductor memory apparatus as depicted in FIG. 2 is configured to store the second and third temperature information signals ‘temp_s2’ and ‘temp_s3’ by using the first test signal ‘test1’ that is first enabled among the sequentially enabled first to third test signals ‘test1 to test3’. When the first test signal ‘test1’ is enabled, the temperature information output circuit is configured to output the first temperature information signal ‘temp_s1’. When the second test signal ‘test2’ is enabled, the temperature information output circuit is configured to output the stored second temperature information signal ‘temp_s2’. When the third test signal ‘test3’ is enabled, the temperature information output circuit is configured to output the stored third temperature information signal ‘temp_s3’.

Consequently, the temperature information outputting circuit of the semiconductor memory apparatus, as depicted for example in FIG. 2, can store the plurality temperature information signals at a specific times. That is, at times when a test signal is first enabled and sequentially outputs the stored signals to one pad, which makes it possible to more accurately perform the temperature measuring test.

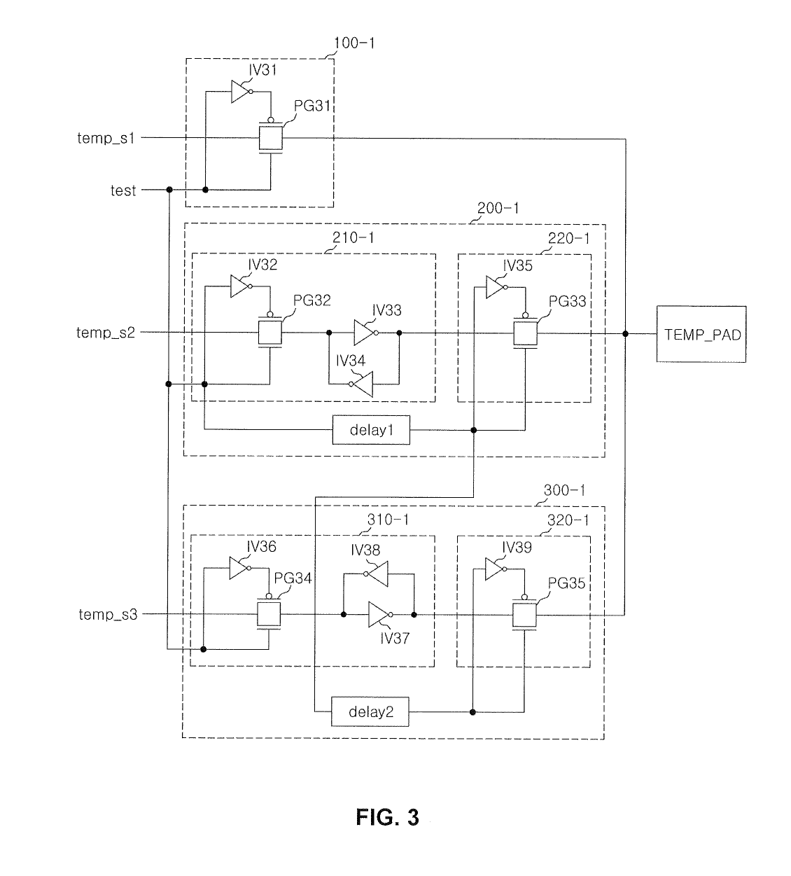

The temperature information outputting circuit of the semiconductor memory apparatus as depicted in FIG. 3 is configured to include a first temperature information outputting unit 100-1; a second temperature information outputting unit 200-1; and a third temperature information outputting unit 300-1.

The first temperature information outputting unit 100-1 is configured to output the first temperature information signal ‘temp_s1’ to the temperature information outputting pad ‘TEMP_PAD’ when the test signal ‘test’ is enabled.

The first temperature information outputting unit 100-1 is configured to include a first inverter ‘IV31’ and a first pass gate ‘PG31’. The first inverter ‘IV31’ is configured to receive the test signal ‘test’. The first pass gate ‘PG31’ is configured to have a first control end that receives an output signal from the first inverter ‘IV31’; a second control end that receives the test signal ‘test’; and an input end that receives a first temperature information signal ‘temp_s1’.

The second temperature information outputting unit 200-1 is configured to store the second temperature information signal ‘temp_s2’ when the test signal ‘test’ is enabled. The second temperature information outputting unit 200-1 is also configured to output the stored second temperature information signal ‘temp_s2’ when a preset time elapses after the test signal ‘test’ is enabled.

The second temperature information outputting unit ‘200-1’ is configured to include a first latch unit ‘210-1’ and a first delay unit ‘delay1’, and a first switching unit ‘220-1’.

The first latch unit ‘210-1’ is configured to store the second temperature information signal ‘temp_s2’ when the test signal ‘test’ is enabled.

The first latch unit ‘210-1’ is configured to include second to fourth inverters ‘IV32’ to ‘IV34’ and a second pass gate ‘PG32’. The second inverter ‘IV32’ is configured to receive the test signal ‘test’. The second pass gate ‘PG32’ is configured to have a first control end that receives an output signal from the second inverter ‘1V32’; a second control end that receives the test signal ‘test’; and an input end that receives the second temperature information signal ‘temp_s2’. The third inverter ‘IV33’ is configured to receive an output signal from the second pass gate ‘PG32’. The fourth inverter ‘IV34’ is configured to receive an output signal from the third inverter ‘IV33’ and is configured to output its own output signal as an input signal from the third inverter ‘IV33’.

The first delay unit ‘delay1’ is configured to delay an output of the test signal ‘test’.

The first switching unit ‘220-1’ responds to an output signal from the first delay unit ‘delay1’ to output an output signal from the first latch unit ‘210-1’ to the temperature information outputting pad ‘TEMP_PAD’.

The first switching unit ‘220-1’ is configured to include a fifth inverter ‘IV35 ’ and a third pass gate ‘PG33’. The fifth inverter ‘IV35’ is configured to receive an output signal from the first delay unit ‘delay1’. The third pass gate ‘PG33’ is configured to have a first control end that receives an output signal from the fifth inverter ‘IV35’; a second control end that receives an output signal from the first delay unit ‘delay1’; an input end that receives an output signal from the first latch unit ‘210-1’; and an output end that is connected to the temperature information outputting pad ‘TEMP_PAD’.

The third temperature information outputting unit ‘300-1’ is configured to store the third temperature information signal ‘temp_s3’ when the test signal ‘test’ is enabled. The third temperature information outputting unit ‘300-1’ is also configured to output the stored third temperature information signal ‘temp_s3’ when the preset time further elapses after the test signal ‘test’ is enabled.

The third temperature information outputting unit ‘300-1’ is configured to include a second latch unit ‘310-1’, a second delay unit ‘delay2’, and a second switching unit ‘320-1’.

The second latch unit ‘310-1’ is configured to store the third temperature information signal ‘temp_s3’ when the test signal ‘test’ is enabled.

The second latch unit ‘310-1 ’ is configured to include sixth to eighth inverters ‘IV36’ to ‘IV38’ and a fourth pass gate ‘PG34’. The sixth inverter ‘IV36’ receives the test signal ‘test’. The fourth pass gate ‘PG34’ is configured to have a first control end that receives an output signal from the sixth inverter ‘IV36’; a second control end that receives the test signal ‘test’; and an input end that receives the third temperature information signal ‘temp_s3’. The seventh inverter ‘IV37’ is configured to receive an output signal from the fourth pass gate ‘PG34’. The eighth inverter ‘IV34’ is configured to receive an output signal from the seventh inverter ‘IV37’ and is configured to output its own output signal as an input signal of the seventh inverter ‘IV37’.

The second delay unit ‘delay2’ is configured to delay an output signal from the first delay unit ‘delay1’.

The second switching unit ‘320-1’ is configured to respond to an output signal from the second delay unit ‘delay2’ and to output an output signal from the second latch unit ‘310-1’ to the temperature information outputting pad ‘TEMP_PAD’.

The second switching unit ‘320-1’ is configured to include a ninth inverter ‘IV39 ’ and a fifth pass gate ‘PG35’. The ninth inverter ‘IV39’ is configured to receive an output signal from the second delay unit ‘delay2’. The fifth pass gate ‘PG35’ is configured to have a first control end that receives an output signal from the ninth inverter ‘IV39’; a second control end that receives an output signal from the second delay unit ‘delay2’; an input end that receives an output signal from the second latch unit ‘310-1’; and an output end that is connected to the temperature information outputting pad ‘TEMP_PAD’.

The temperature information outputting circuit of the semiconductor memory apparatus according to the embodiment configured as above is operated as follows.

The first to third temperature information signals ‘temp_s1’ to ‘temp_s3’ are simultaneously output from a temperature detecting circuit (not shown).

The first temperature information signal ‘temp_s1’ is output to the temperature information outputting pad ‘TEMP_PAD’ when the test signal ‘test’ is enabled.

When the test signal ‘test’ is enabled, the second temperature information signal ‘temp_s2’ is stored and the stored second temperature information signal ‘temp_s2’ is output to the temperature information outputting pad ‘TEMP_PAD’ when the preset time (a delayed time of the first delay unit ‘delay1’) elapses after the test signal ‘test’ is enabled.

When the test signal ‘test’ is enabled, the third temperature information signal ‘temp_s3’ is stored and the stored third temperature information signal ‘temp_s3’ is output to the temperature information outputting pad ‘TEMP_PAD’ when the preset time further elapses (a delayed time of the first delay unit ‘delay1’ elapses and a delayed time of the second delay unit ‘delay2’ further elapses) after the test signal ‘test’ is enabled.

Consequently, the temperature information outputting circuit of the semiconductor memory apparatus according to this embodiment is configured to store the second and third temperature information signals ‘temp_s2’, ‘temp_s3’ when the test signal ‘test’ is enabled. When the test signal ‘test’ is enabled, the first temperature information signal ‘temp_s1’ is output. When the delayed time of the first delay unit ‘delay1’ elapses after the test signal ‘test’ is enabled, the stored second temperature information signal ‘temp_s2’ is output. When the stored second temperature information signal ‘temp_s2’ is output and when the delayed time of the second delay unit ‘delay 2’ elapses, then the stored third temperature information signal ‘temp_s3’ is output.

Consequently, the temperature information outputting circuit of the semiconductor memory apparatus can store the plurality temperature information signals at a specific timing sequence, that is, at a time when the test signal is enabled and sequentially can output the stored signals to one pad. It makes it possible to more accurately perform the temperature measuring test.

As such, the embodiment can simultaneously store the information codes (for example, the plurality of temperature information signals) that are changed in real time and sequentially output each bit of the stored information codes to the outside of the semiconductor memory apparatus through a single pad. At this time, the timing of storing the information code uses the test signal that is first enabled among the sequentially enabled test signals and responds to each test signal to sequentially output each bit of the stored information codes. Further, the embodiment can include a plurality of delay units that simultaneously store each bit of the information codes at a timing when one test signal is enabled and sequentially outputs each of the simultaneously stored bits.

While certain embodiments have been described above, it will be understood to those skilled in the art that the embodiments described are by way of example only. Rather, the right scope of the present invention is defined only by claims. All modifications and changes derived from the meanings, scope, and equivalents of claims should be construed as being included in the scope of the present invention.

What is claimed is:

1. A temperature information outputting circuit of a semiconductor memory apparatus for accurately performing a temperature measuring test, the semiconductor memory apparatus comprising:
the temperature information outputting circuit configured to respond to a plurality of test signals when the test signals are enabled by storing a plurality of corresponding temperature information signals and configured to respond to the enabled test signals by sequentially outputting the stored temperature information signals to one temperature information outputting pad.

2. The semiconductor memory apparatus of claim 1, wherein the temperature information outputting circuit includes:
a plurality of latch units configured to respond to the test signals when the test signals are enabled by simultaneously storing respectively the temperature information signals; and
a plurality of switching units configured to sequentially and respectively respond to the test signals when the test signals are sequentially enabled by outputting the temperature information signals stored in the latch units,
wherein a node to which each output end of the switching units is commonly connected to the one temperature information outputting pad.

3. The semiconductor memory apparatus of claim 1, wherein the temperature information outputting circuit includes:
a plurality of temperature information outputting units configured to respond to the test signals when the test signals are enabled by simultaneously storing the temperature information signals,
wherein the temperature information outputting units are configured to sequentially respond to the test signals when the test signals are sequentially enabled by sequentially outputting the stored temperature information signals to the one temperature information outputting pad.

4. A temperature information outputting circuit of a semiconductor memory apparatus for accurately performing a temperature measuring test, the temperature information outputting circuit comprising:
a first temperature information outputting unit configured to output a first temperature information signal to a single temperature information outputting pad when a first test signal is enabled;
a second temperature information outputting unit configured to store a second temperature information signal when the first test signal is enabled and configured to output the stored second temperature information signal to the single temperature information outputting pad when a second test signal is enabled; and
a third temperature information outputting unit configured to store a third temperature information signal when the first test signal is enabled and configured to output the stored third temperature information signal to the single temperature information outputting pad when a third test signal is enabled.

5. The temperature information outputting circuit of claim 4, wherein the first temperature information outputting unit includes:
a switching unit configured to output the first temperature information signal to the single temperature information outputting pad when the first test signal is enabled.

6. The temperature information outputting circuit of claim 4, wherein the second temperature information outputting unit includes:
a latch unit configured to store the second temperature information signal when the first test signal is enabled; and
a switching unit configured to output the second temperature information signal stored in the latch unit to the single temperature information outputting pad when the second test signal is enabled.

7. The temperature information outputting circuit of claim 4, wherein the third temperature information outputting unit includes:
a latch unit configured to store the third temperature information signal when the first test signal is enabled; and
a switching unit configured to output the third temperature information signal stored in the latch unit to the single temperature information outputting pad when the third test signal is enabled.
wherein the first temperature information outputting unit includes:
a switching unit configured to output the first temperature information signal to the single temperature information outputting pad when the first test signal is enabled.

8. The temperature information outputting circuit of claim 4, wherein the first temperature information outputting unit comprises a switching unit configured to output the first temperature information signal to the single temperature information outputting pad when the first test signal is enabled;
the second temperature information outputting unit comprises:
a first latch unit configured to store the second temperature information signal when the first test signal is enabled, and
a switching unit configured to output the second temperature information signal stored in the first latch unit to the single temperature information outputting pad when the second test signal is enabled;
the third temperature information outputting unit comprises:
a second latch unit configured to store the third temperature information signal when the first test signal is enabled, and
a switching unit configured to output the third temperature information signal stored in the second latch unit to the single temperature information outputting pad when the third test signal is enabled.

9. The temperature information outputting circuit of claim 4, wherein the temperature information outputting circuit stores the first, second, and third temperature information signals at specific times and sequentially outputs the stored first, second, and third temperature information signals to the single temperature information outputting pad.

10. The temperature information outputting circuit of claim 9, wherein when the first, second, and third test signals are sequentially enabled, then the respective first, second, and third temperature information signals are simultaneously stored and are sequentially outputted to the single temperature information outputting unit.

11. The temperature information outputting circuit of a semiconductor memory apparatus for accurately performing a temperature measuring test, the temperature information outputting circuit comprising:
a first temperature information outputting unit configured to output to a single pad a first temperature information signal when a test signal is enabled;
a second temperature information outputting unit configured to store the second temperature information signal when the test signal is enabled and to output to the single pad the stored second test signal when a first preset time elapses after the test signal is enabled; and
a third temperature information outputting unit configured to store the third temperature information signal when the test signal is enabled and to output to the single pad the stored third signal when a second preset time further elapses after the test signals are enabled.

12. The temperature information outputting circuit claim 11, wherein the first temperature information outputting unit includes a switching unit that is configured to output the first temperature information signal when the test signal is enabled.

13. The temperature information outputting circuit of claim 11, wherein the second temperature information outputting unit includes:
a first latch unit configured to store the second temperature information signal when the test signal is enabled;
a first delay unit configured to receive and to delay the test signal; and
a first switching unit configured to respond to an output signal from the first delay unit and to output the second temperature information signal from the first latch unit.

14. The temperature information outputting circuit of claim 13, wherein the third temperature information outputting unit includes:
a second latch unit configured to store the third temperature information signal when the test signal is enabled;
a second delay unit configured to receive and to delay an output signal from the first delay unit; and
a second switching unit configured to respond to an output signal from the second delay unit to output the third temperature information signal from the second latch unit.

15. The temperature information outputting circuit of claim 14, wherein the semiconductor memory apparatus includes:
a plurality of latch units configured to respond to the test signal, which is first enabled, to simultaneously store each bit of the information codes; and
a plurality of switching units configured to respond to each of the plurality of test signals and sequentially outputs each bit of the information codes stored in each of the plurality of latch units to the single pad.

16. The temperature information outputting circuit of claim 14, wherein the third temperature information signal from the second switching unit is output after the second temperature information signal from the first switching unit.

17. The temperature information outputting circuit of claim 14, wherein a first temperature information signal outputted from the first temperature information outputting unit is before the second temperature information signal outputted from the second temperature information outputting unit, and the third temperature information signal is outputted from the third temperature information outputting unit is outputted after the second temperature information signal from the second temperature information outputting unit.

18. The temperature information outputting circuit of claim 14, wherein the second preset time is longer than the first preset time.

19. The temperature information outputting circuit of claim 11 wherein
the first temperature information outputting unit includes a switching unit that is configured to output the first temperature information signal when the test signal is enabled;
the second temperature information outputting unit includes a first latch unit configured to store the second temperature information signal when the test signal is enabled, a first delay unit configured to receive and to delay the test signal; and a first switching unit configured to respond to an output signal from the first delay unit and to output the second temperature information signal from the first latch unit; and
the third temperature information outputting unit includes: a second latch unit configured to store the third temperature information signal when the test signal is enabled, a second delay unit configured to receive and to delay the output signal from the first delay unit, and a second switching unit configured to respond to an output signal from the second delay unit to output the third temperature information signal from the second latch unit.
